(19) United States
(12) Patent Application Publication
(10) Pub. No.: US 2005/0126649 A1
(43) Pub. Date: Jun. 16, 2005

(54) Check valve and pump including the same

(75) Inventor: Hitoshi Onishi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/000,708

(22) Filed: Dec. 1, 2004

(30) Foreign Application Priority Data
Dec. 15, 2003 (JP) 2003-416949

(51) Int. Cl. F16K 15/14

(52) U.S. Cl. 137/854

(57) ABSTRACT

A check valve includes a valve component composed of an elastic material and having a flat circular seal and a shaft extending from the center of the seal; and a partition having a valve-supporting hole sustaining the valve component, a thin circular portion centered at the valve-supporting hole and having a diameter smaller than the seal, and vents through the thin circular portion. The shaft of the valve component is sustained by the valve-supporting hole in the partition, and the seal is deformed toward the partition such that the bottom surface of the seal is in line contact with a circular edge that is defined by the level difference between the partition and the thin circular portion at least in a state where the valve component does not receive fluid pressure.

### BACKGROUND OF THE INVENTION

1. Field of the Invention

The present invention relates to compact and low-profiled check valves having excellent sealing characteristics.

2. Description of the Related Art

As disclosed in Japanese Unexamined Patent Application Publication No. 2000-274374, an umbrella valve having an umbrella-shaped component and a shaft corresponding to a handle of the umbrella disposed in the center of the umbrella-shaped component is well-known as a small-sized check valve. The umbrella-shaped component is disposed on one of two surfaces, i.e. a sealing surface, of a partition so as to cover a hole bored through the partition. The shaft is supported by the partition such that the umbrella-shaped component is deformably brought into contact with the sealing surface. Thus, the umbrella valve functions as a check valve. More specifically, the umbrella valve allows a stream applying a fluid pressure to the inner side of the umbrella-shaped component to flow through the hole by deforming the umbrella-shaped component, while the umbrella valve blocks a stream applying a fluid pressure to the outer side of the umbrella-shaped component.

However, as a result of investigation, the present inventors found that this umbrella valve can have sufficient sealing characteristics only when the sealing surface is sufficiently flat and the sealing surface is in contact with the inner side of the umbrella-shaped component at a uniform pressure. This problem is more remarkable as the umbrella valve is downsized.

Moreover, the umbrella valve is used as a check valve for a low-profiled device, for example, a piezoelectric pump. Since the piezoelectric pump is often used for a water-cooled notebook computer, the piezoelectric pump should be ultrathin, and there has been a demand for thinner umbrella valves. Other types of check valves disclosed in Japanese Unexamined Patent Application Publication Nos. 9-250461, 9-329271, and 2003-90447 have the same problem as the above-described check valve.

### SUMMARY OF THE INVENTION

Accordingly, it is an object of the present invention to provide a compact, low-profiled umbrella-type check valve that includes a valve component composed of a single elastic body and that has excellent sealing characteristics.

The check valve according to the present invention includes a valve component composed of an elastic material and having a flat circular seal and a shaft extending from the center of the seal; and a partition having a valve-supporting hole sustaining the valve component, a thin circular portion centered at the valve-supporting hole and having a diameter smaller than the seal, and vents through the thin circular portion. The shaft of the valve component is sustained by the valve-supporting hole in the partition, and the seal is deformed toward the partition such that the bottom surface of the seal is in line contact with a circular edge that is defined by the level difference between the partition and the thin circular portion at least in a state where the valve component does not receive fluid pressure.

The seal of the valve component may be flat when the valve component is not attached to the partition, and the bottom surface of the seal may be in contact with the thin circular portion at the boundary between the shaft and the seal. Alternatively, the rim of bottom surface of the seal that comes into contact with the circular edge may be annually tapered and the thickness of the seal may be reduced toward the outer rim.

The check valve according to the present invention has excellent sealing characteristics regardless of the planarity of the seal since the bottom surface of seal of the valve component is in line contact with the circular edge defined by the level difference between the partition and the thin circular portion.

### BRIEF DESCRIPTION OF THE DRAWINGS

FIG. 1 is a longitudinal sectional view illustrating an example of a piezoelectric pump including check valves according to the present invention;

FIG. 2 is a longitudinal sectional view illustrating a valve component of the check valve according to the present invention in a free state;

FIG. 3 is a longitudinal sectional view of the valve component shown in FIG. 2 attached to a partition while the check valve is closed;

FIG. 4 is a longitudinal sectional view of the above-described valve component while the check valve is open;

FIG. 5 is a partly sectioned perspective view of the check valve according to the present invention; and

FIG. 6 is a longitudinal sectional view illustrating another embodiment of the check valve according to the present invention.

### DESCRIPTION OF THE PREFERRED EMBODIMENTS

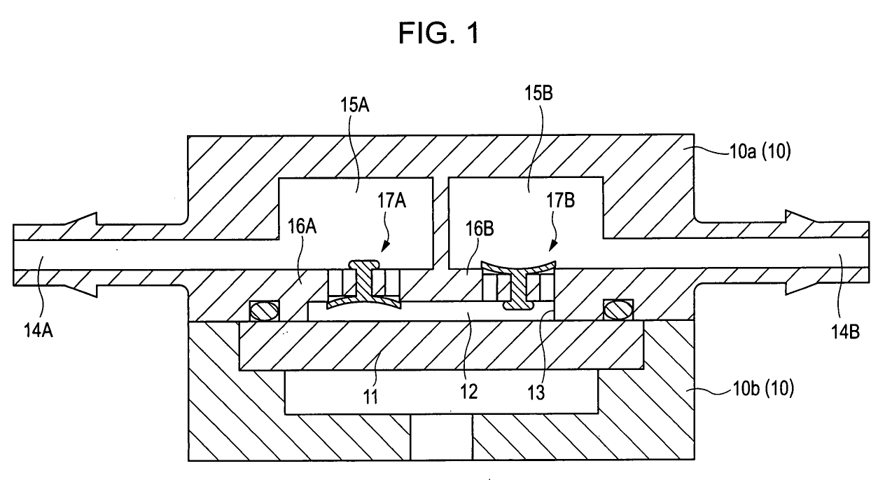

FIG. 1 shows an embodiment of a check valve according to the present invention that is used in a piezoelectric pump. A housing 10 includes an upper housing 10a and a lower housing 10b, and a piezoelectric vibrator 11 is hermetically clamped therebetween. The thickness of the piezoelectric vibrator 11 is exaggerated for purposes of illustration, and the actual thickness is less than 1.5 mm. The upper housing 10a has a hollow section 13, and a variable chamber 12 is formed between the hollow section 13 and the piezoelectric vibrator 11.

The upper housing 10a has an inlet 14A and an outlet 14B for liquid, i.e. cooling water. The inlet 14A communicates with an inlet reservoir 15A, whereas the outlet 14B communicates with an outlet reservoir 15B. A partition 16A is disposed between the inlet reservoir 15A and the variable chamber 12 and a partition 16B is disposed between the outlet reservoir 15B and the variable chamber 12. Check valves 17A and 17B are attached to the partitions 16A and 16B, respectively. The check valve 17A allows a stream from the inlet 14A (the inlet reservoir 15A), to the variable chamber 12, and blocks a stream in the opposite direction. On the other hand, the check valve 17B allows a stream from the variable chamber 12 to the outlet 14B (the outlet reservoir 15B), and blocks a stream in the opposite direction.

In the above-described piezoelectric pump, when the piezoelectric vibrator 11 deforms to expand the capacity of the variable chamber 12, the check valve 17A opens and the check valve 17B closes, and thus the liquid flows from the inlet 14A (inlet reservoir 15A) into the variable chamber 12. Alternately, when the piezoelectric vibrator 11 deforms to reduce the capacity of the variable chamber 12, the check valve 17B opens and the check valve 17A closes, and thus the liquid flows from the variable chamber 12 into the outlet 14B (outlet reservoir 15B). Accordingly, liquid can be pumped by alternately deforming, or vibrating, the piezoelectric vibrator 11. Such a piezoelectric vibrator is well known.

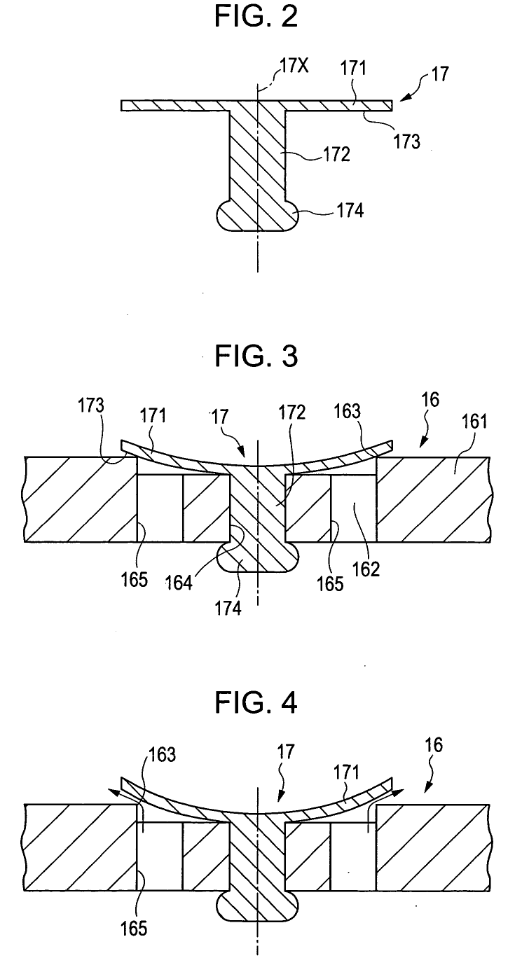

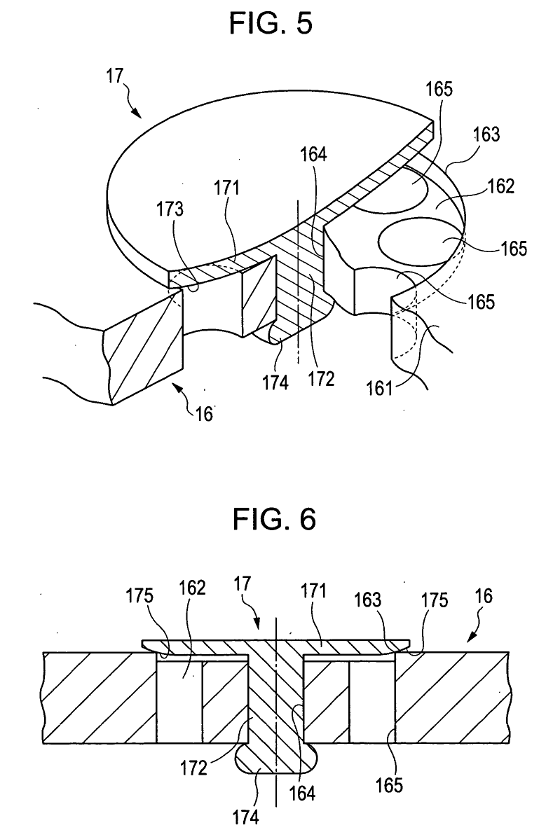

The structures of the check valves 17A and 17B are the same, and each include a valve component 17 and a partition 16. The valve component 17 and the partition 16 will now be described with reference to FIGS. 2 to 5.

The valve component 17 shown in FIG. 2 is symmetrical with respect to an axis 17X. The valve component 17 is composed of a single elastic body, and includes a disk seal 171 and a shaft 172 extending orthogonally from the bottom center of the seal 171. The bottom surface 173 of the seal 171 is preferably flat in a free state, i.e. when the valve component 17 is not attached to the partition 16. The shaft 172 has a stop shoulder 174 at the tip thereof.

The partition 16 is substantially flat, and includes a flat (thick) portion 161 opposing the outer rim of the bottom surface of the seal 171 and a thin circular portion 162 formed in the flat portion 161. The level difference between the flat portion 161 and the thin circular portion 162 forms a circular edge 163.

A valve-supporting hole 164 that sustains the valve component 17 is formed at the center of the thin circular portion 162, and a plurality of vents 165 are formed around the valve-supporting hole 164. These vents 165 communicate with both the variable chamber 12 and the inlet reservoir 15A or outlet reservoir 15B shown in FIG. 1. The shaft 172 of the valve component 17 is fitted into the valve-supporting hole 164 of the partition 16, and is fixed thereto by the stop shoulder 174 that protrudes radially from the valve-supporting hole 164.

When the shaft 172 is fixed to the valve-supporting hole 164, and at least in a state where the seal 171 does not receive fluid pressure, the bottom surface of the seal 171 is in line contact with the circular edge 163 at a position adjacent to the outer rim of the seal 171. In other words, the bottom surface of the flat seal 171 is deformed to be in contact with the thin circular portion 162 at the boundary between the shaft 172 and the seal 171, and consequently, the bottom surface of the seal 171 comes into line contact with the circular edge 163 at a position adjacent to the outer rim of the seal 171, instead of surface contact with the flat portion 161. The position of the stop shoulder 174 of the shaft 172, i.e. the length of the valve-supporting hole 164, is determined such that the seal 171 is deformed as described above. The term “line contact” in this specification does not mean a geometric contact, but a contact of the bottom surface of the seal 171 and the circular edge 163 at the highest contact pressure that can achieve high sealing characteristics.

As shown in FIG. 3, when the pressure at the top surface of the seal 171 of the valve component 17 is high, the seal 171 is pressed against the circular edge 163 at a high contact pressure to close the fluid channel. As shown in FIG. 4, when the pressure at the bottom surface of the seal 171 is high, the seal 171 is separated from the circular edge 163 to open the fluid channel. In this manner, the above-described structure functions as a check valve. When the check valve is closed, the seal 171 of the valve component 17 is in line contact with the circular edge 163 of the partition 16. As a result, higher sealing characteristics can be achieved compared to a known umbrella valve whose seal is in surface contact with a flat portion. The planarity of the flat portion 161 has little effect on the sealing characteristics. Moreover, when the check valve is open, the fluid channel is smoother and the channel resistance is lower compared to the umbrella valve. In addition, the check valve can be low-profiled compared to the known umbrella valve having an umbrella-shaped valve component.

FIG. 6 illustrates another embodiment of the check valve according to the present invention. In this embodiment, an annularly tapered surface 175 is formed along the rim of the bottom surface of flat seal 171 of the valve component 17 by reducing the thickness of the seal 171 toward the outer rim to secure the line contact with the circular edge 163.

1. A check valve comprising:
a valve component composed of an elastic material and having a flat circular seal and a shaft extending from a center of the seal; and
a partition having a valve-supporting hole sustaining the valve component, a thin circular portion centered at the valve-supporting hole and having a diameter smaller than the seal, and vents through the thin circular portion, wherein
the shaft of the valve component is sustained by the valve-supporting hole in the partition; and
the seal is deformed toward the partition such that a bottom surface of the seal is in line contact with a circular edge that is defined by the level difference between the partition and the thin circular portion at least in a state where the valve component does not receive fluid pressure.

2. The check valve according to claim 1, wherein
the seal of the valve component is flat when the valve component is not attached to the partition; and
the bottom surface of the seal is in contact with the thin circular portion at a boundary between the shaft and the seal.

3. The check valve according to claim 1, wherein
the seal of the valve component is flat when the valve component is not attached to the partition; and
a rim of the bottom surface of the seal is annually tapered and a thickness of the seal is reduced toward an outer rim.

4. A pump comprising the check valve according to claim 1.
